(19) United States
(12) Patent Application Publication
(10) Pub. No.: US 2026/0079829 A1
(43) Pub. Date: Mar. 19, 2026

(54) STORAGE SYSTEM AND OPERATING METHOD THEREOF

(71) Applicant: SK hynix Inc., Gyeonggi-do (KR)

(72) Inventor: Seok Jeong HAN, Gyeonggi-do (KR)

(21) Appl. No.: 18/991,696

(22) Filed: Dec. 23, 2024

(30) Foreign Application Priority Data
Sep. 19, 2024 (KR) 10-2024-0126479

(51) Int. Cl. G06F 12/02

(52) U.S. Cl. CPC G06F 12/0246

(57) ABSTRACT

A storage system includes a memory, a secured storage area and a meta storage area, and a controller. The controller buffers L first data chunks in the memory, reads a read data group from the secured storage area, and stores a write data group including the L first data chunks and M second data chunks in the secured storage area and stores invalidity information on each of the first and second data chunks in the meta storage area. Each of the read data group and the write data group may include N (=L+M) chunks, and the read data group may include the second data chunks.

### CROSS-REFERENCE TO RELATED APPLICATIONS

The present application claims priority under 35 U.S.C 119(a) to Korean Patent Application No. 10-2024-0126479, filed on Sep. 19, 2024, which is incorporated herein by reference in its entirety.

### BACKGROUND

### 1. Field

Various embodiments of the present disclosure relate to an electronic device, and more particularly, to a storage system including a storage device and a controller, and an operating method thereof.

### 2. Discussion of the Related Art

A storage system may store data or read the stored data under the control of a host device included in a computer, a smart phone, or the like. The storage system may include a storage device that stores data and a controller that controls the storage device. The storage device may be nonvolatile.

The nonvolatile storage device is a memory device in which data is not lost even though power is cut off, and includes a read only memory (ROM), a programmable ROM (PROM), an electrically programmable ROM (EPROM), an electrically erasable and programmable ROM (EEPROM), a flash memory, and the like.

### SUMMARY

Various embodiments of the present disclosure are directed to providing a storage system capable of identifying, even when a partial number of data chunks are invalid within a data group including a predetermined number of data chunks, the remaining number of data chunks as valid within the data group, and an operating method thereof.

In accordance with an embodiment of the present disclosure, an operating method of a storage system may include buffering an L number of first data chunks in a memory, L being a natural number of 1 or more; reading a read data group from a storage device; and storing a write data group, which comprises the L number of first data chunks and an M number of second data chunks in the storage device and storing invalidity information on each of the first and second data chunks in the storage device, M being a natural number of 1 or more. Each of the read data group and the write data group may include an N (=L+M) number of chunks, and the read data group may include the second data chunks.

The operating method may further include reading, from the storage device, the invalidity information on each of chunks included in the read data group. The read invalidity information may include the invalidity information on each of the second data chunks.

The read data group may be read from a replay protected memory block (RPMB) included in the storage device. The write data group may be stored in the RPMB.

The read data group may be read from a secured area included in the storage device.

The secured area may be accessible according to authentication.

The write data group may be stored in a secured area included in the storage device.

The secured area may be accessible according to authentication.

The invalidity information may be stored in a meta-area included in the storage device.

The invalidity information may be read from a meta-area included in the storage device.

In accordance with an embodiment of the present disclosure, a storage system may include a memory, a secured storage area and a meta storage area, and a controller. The controller may be configured to buffer an L number of first data chunks in the memory, L being a natural number of 1 or more, read a read data group from the secured storage area, and store a write data group, which comprises the L number of first data chunks and an M number of second data chunks in the secured storage area and store invalidity information on each of the first and second data chunks in the meta storage area, M being a natural number of 1 or more. Each of the read data group and the write data group may comprise an N (=L+M) number of chunks. The read data group may comprise the second data chunks.

The controller may be further configured to read, from the meta storage area, the invalidity information on each of chunks included in the read data group. The read invalidity information may include the invalidity information on each of the second data chunks.

The secured storage area may include a replay protected memory block (RPMB).

The secured storage area may be accessible according to authentication.

In accordance with an embodiment of the present disclosure, even when a partial number of data chunks are invalid within a data group including a predetermined number of data chunks, the remaining number of data chunks may be identified as valid within the data group.

### BRIEF DESCRIPTION OF THE DRAWINGS

FIG. 1 schematically illustrates a computing system to which an embodiment of the present disclosure can be applied.

FIG. 2 schematically illustrates a write operation using a read-back merge scheme in accordance with an embodiment of the present disclosure.

FIG. 3 to FIG. 7 schematically illustrate data groups, host/read chunks, and invalid information in accordance with an embodiment of the present disclosure.

### DETAILED DESCRIPTION

Hereinafter, embodiments of the present disclosure are described in detail with reference to the accompanying drawings. The embodiments of the present disclosure are ones provided to make those skilled in the art to more completely understand the present disclosure. Since the technical scope of the present disclosure can be implemented in various embodiments, the present disclosure illustrates and describes specific embodiments in the drawings. However, this is not intended to limit the present disclosure to a specific disclosed embodiment and should be understood to include all changes, equivalents, and substitutes included in the spirit and technical scope of the present disclosure. When describing each drawing, similar reference numerals are used for similar components. In the accompanying drawings, the dimensions of the structures are enlarged or reduced from the actual size in order to ensure the clarity of the present disclosure.

The terms used in the present disclosure are merely used to describe specific embodiments and are not intended to limit the embodiments of the present disclosure. Singular expressions include plural expressions unless the context clearly dictates otherwise. In this specification, terms such as “comprises” or “has” are intended to designate the presence of features, numbers, steps, operations, components, parts, or combinations thereof described in the specification, and should be understood as not excluding the presence or addition of one or more other features, numbers, steps, operations, components, parts or combinations thereof.

Terms such as first and second may be used to describe various components, but the components should not be limited by the above terms. The above terms may be used to distinguish one component from another component. For example, a first component may be referred to as a second component and similarly, the second component may also be referred to as a first component without departing from the scope of the present disclosure.

Unless otherwise defined, all terms used herein, including technical or scientific terms, have the same meaning as commonly understood by a person of ordinary skill in the technical field to which the present disclosure pertains. Terms such as those defined in generally used dictionaries should be interpreted as having meanings consistent with the meanings of the relevant technology in the context, and unless clearly defined in the present disclosure, should not be interpreted in an idealized or overly formal sense.

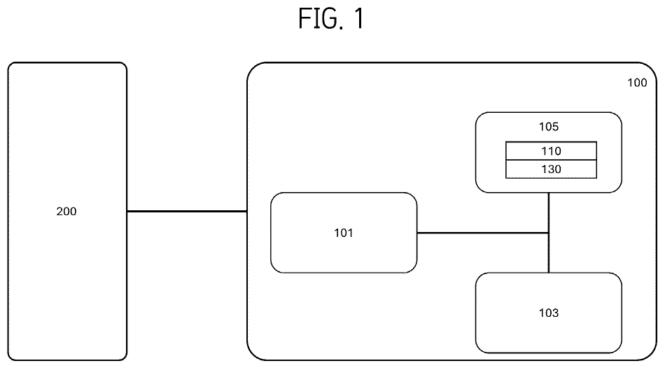

FIG. 1 schematically illustrates a computing system to which an embodiment of the present disclosure can be applied.

The computing system may be a device that is mounted on a mobile phone, a smart phone, an MP3 player, a laptop computer, a desktop computer, a game machine, a display device, a tablet PC, or an in-vehicle infotainment system, or the like and can store data.

The computing system may communicate with an external system through various communication methods with data stored in the computing system. The computing system's communication connection with the external system may include communicating through a third device (for example, a repeater, a hub, an access point, a server, or a gateway).

The computing system may include various communication modules in order to communicate with the external system. For example, the computing system may include a wireless communication module, and may include, for example, a cellular communication module using at least one of long term evolution(LTE), LTE Advance (LTE-A), code division multiple access (CDMA), wideband CDMA (WCDMA), universal mobile telecommunications system (UMTS), wireless broadband (WiBro), and global system for mobile communications (GSM). As another example, the wireless communication module may include wireless fidelity (WiFi), radio frequency (RF), body area network (BAN), or the like.

The external system may communicate with the computing system. For example, the external system may include a smartphone, a tablet PC, a mobile phone, a video phone, an e-book reader, a desktop PC, a laptop PC, a netbook computer, a workstation, a server, a PDA, a portable multimedia player (PMP), an MP3 player, a medical device, a camera, a wearable device, or the like. The wearable device may include at least one of an accessory type circuit (for example, a watch, a ring, a bracelet, an anklet, a necklace, glasses, contact lenses, or a head-mounted device (HMD)), a fabric or clothing-integrated type circuit (for example, an electronic garment), a body-attached type circuit (for example, a skin pad or a tattoo), and a bio-implantable circuit.

The external system may include a television, a digital video disk (DVD) player, an audio system, a refrigerator, an air conditioner, a vacuum cleaner, an oven, a microwave oven, a washing machine, an air cleaner, a set-top box, a home automation control panel, a security control panel, a media box (for example, Samsung HomeSync, Apple TV, or Google TV), a game console (for example, Xbox, PlayStation), an electronic dictionary, an electronic key, a camcorder, an electronic picture frame, or the like.

The computing system and the external system may perform a function of sharing data through mutual communication or providing services to a user by using the shared data. In particular, the computing system may share security data including a user's fingerprint, password, or the like with the external system, and the external system may provide a user with a service (for example, a payment service) that requires security data by using the security data received from the computing system. The “service” may mean a function provided by an application or a function provided by the computing system. For example, in a payment-related application, the “service” may be a series of processes for performing an operation corresponding to a user's payment request.

Referring to FIG. 1, the computing system may include a nonvolatile storage system 100 and a host system 200.

The nonvolatile storage system 100 may include a controller 101, a working memory 103, and a nonvolatile storage device 105. The nonvolatile storage system 100 operates in response to a request from the host system 200, and in particular, may store data accessed by the host system 200. That is, the nonvolatile storage system 100 may be used as a main memory device or an auxiliary memory device of the host system 200. The nonvolatile storage system 100 may be implemented with one or a combination of various types of storage devices according to an interface protocol connected to the host system 200. For example, the nonvolatile storage system 100 may be implemented with one or a combination of various types of storage devices such as a solid state drive (SSD), an MMC, an embedded MMC (eMMC), a reduced size MMC (RS-MMC), a multimedia card (MMC) in the form of a micro-MMC, a secure digital (SD) card in the form of an SD, a mini-SD, or a micro-SD, a universal storage bus (USB) storage device, a universal flash storage (UFS) device, a compact flash (CF) card, a smart media card, and a memory stick.

The controller 101 and the nonvolatile storage device 105 may be integrated into one semiconductor device. For example, the controller 101 and the nonvolatile storage device 105 may be integrated into one semiconductor device to form an SSD. When the above nonvolatile storage system 100 is used as an SSD, the operating speed of the host system 200 connected to the nonvolatile storage system 100 may be further improved. In addition, the controller 101 and the nonvolatile storage device 105 may be integrated into one semiconductor device to form a memory card, and for example, a memory card such as a PC card (personal computer memory card international association (PCMCIA), a compact flash card (CF), a smart media card (SM or SMC), a memory stick, a multimedia card (MMC, RS-MMC, or MMCmicro), an SD card (SD, miniSD, microSD, or SDHC), and a universal flash memory device (UFS).

As another example, the nonvolatile storage system 100 may form a computer, an ultra mobile PC (UMPC), a workstation, a net-book, a personal digital assistants (PDA), a portable computer, a web tablet, a tablet computer, a wireless phone, a mobile phone, a smart phone, an e-book, a portable multimedia player (PMP), a portable game machine, a navigation device, a black box, a digital camera, a digital multimedia broadcasting (DMB) player, a 3-dimensional television, a smart television, a digital audio recorder, a digital audio player, a digital picture recorder, a digital picture player, a digital video recorder, a digital video player, a storage included in a data center, a device capable of transmitting and receiving information in a wireless environment, one of various electronic devices included in a home network, one of various electronic devices included in a computer network, one of various electronic devices included in a telematics network, a radio frequency identification (RFID) device, or one of various components included in a computing system.

The nonvolatile storage device 105 may retain stored data even though power is not supplied, and in particular, may store data provided from the host system 200 through a write operation and provide the stored data to the host system 200 through a read operation. The nonvolatile storage device 105 may include a memory cell array including a plurality of memory cells that store data.

The memory cell array may include a plurality of memory blocks. Each memory block may include a plurality of pages, and each page may include a plurality of memory cells. For example, each memory cell may be a single level cell (SLC) that stores one data bit, a multilevel cell (MLC) that stores two data bits, a triple level cell (TLC) that stores three data bits, or a quad level cell (QLC) that may store four data bits. For example, the nonvolatile storage device 105 may perform a write operation for storing normal data or a read operation for reading the stored normal data in units of pages. For example, the nonvolatile storage device 105 may perform an erase operation for removing data in units of memory blocks. The normal data is distinguished from secured data stored in RPMB, for example, RPMB data. The RPMB and RPMB data are described below.

The plurality of memory blocks included in the nonvolatile storage device 105 may form a secured area 110, to which access is restricted. The secured area 110 may be a part of a storage area included in the nonvolatile storage device 105. The secured area 110 may store therein secured data (for example, RPMB data) and may be accessed according to authentication. Another part of the storage area included in the nonvolatile storage device 105 may store therein normal data and may be accessed without authentication. Additional conditions or procedures may be required in order to access the secured area 110. For example, the secured area 110 can be accessed only when the storage system 100 receives a predetermined specific command or when authentication performed by the controller 101 is successful. For example, the secured area 110 may be configured as a replay protected memory block (RPMB).

The RPMB is a memory block used to provide a security function. The RPMB is mainly integrated into a flash storage device such as eMMC or UFS, and serves to protect the integrity and authentication of important data. The RPMB has been designed to prevent replay attacks to data in a security-sensitive environment. The RPMB may be physically separated from a normal storage area, and accordingly, it is not possible to read or write data from or into the RPMB through a normal approach. The RPMB ensures safe storage and authentication of data in various applications through the security function described above and may be usefully used particularly in environments where security is important.

Security data stored in the RPMB cannot be accessible without authorization. Read and write operations for the RPMB are possible through successfully authenticated access. For example, security data may be user information including a user's password, user's fingerprint information, user's iris information, and the like. According to one embodiment, the nonvolatile storage system 100 may perform read and write operations on the RPMB in units of chunks. For example, the nonvolatile storage system 100 may store normal data in the nonvolatile storage device 105 or read the normal data from the nonvolatile storage device 105 in units of page size of 4K bytes, while storing or reading security data into or from the nonvolatile storage device 105 in units of chunks each having a size of 256 bytes.

In the present disclosure, for convenience, the secured area 110 is described as being configured as the RPMB; however, the embodiments of the present disclosure are not limited to the secured area 110 or an area configured as the RPMB that does not deviate from the technical spirit and scope of the present disclosure.

In addition, the plurality of memory blocks included in the nonvolatile storage device 105 may form a meta-area 130. The meta-area 130 may be a part of the storage area included in the nonvolatile storage device 105. The meta-area 130 is described below.

The nonvolatile storage device 105 may be configured to receive a command and an address from the controller 101, and to access an area selected by the address from the memory cell array. The nonvolatile storage device 105 may perform an operation indicated by the command on the area selected by the address. For example, the nonvolatile storage device 105 may perform a program operation, a read operation, and an erase operation. The nonvolatile storage device 105 programs data in the area selected by the address through the program operation. The nonvolatile storage device 105 reads data from the area selected by the address through the read operation. The nonvolatile storage device 105 removes data stored in the area selected by the address through the erase operation.

The controller 101 may control the overall operation of the nonvolatile storage system 100.

The controller 101 may execute firmware. When the nonvolatile storage device 105 is implemented with a flash memory, the firmware may include a host interface layer, a flash translation layer, and a flash interface layer. The host interface layer may interface the host system 200 and the nonvolatile storage system 100. For example, the host interface layer may receive a request provided from the host system 200 or provide a response to the host system 200. The flash translation layer may bidirectionally convert a logical area recognized by the host system 200 and a physical area recognized by the nonvolatile storage device 105. For example, the flash translation layer may generate a command for the nonvolatile storage device 105 based on a request provided from the host system 200. For example, the flash translation layer may bidirectionally convert a logical address recognized by the host system 200 and a physical address recognized by the nonvolatile storage device 105 and may manage map data defining the relationship between the logical address and the physical address. The flash interface layer may interface the controller 101 and the nonvolatile storage device 105. For example, the flash interface layer may provide a command to the nonvolatile storage device 105 or receive a response from the nonvolatile storage device 105.

The controller 101 may convert, into a physical address, a logical address provided by the host system 200. The physical address may indicate the storage area included in the nonvolatile storage device 105.

The controller 101 may control the nonvolatile storage device 105 to perform a program operation, a read operation, an erase operation, and the like according to a request from the host system 200. In the program operation, the controller 101 may provide a program command, a physical address, and data to the nonvolatile storage device 105. In the read operation, the controller 101 may provide a read command and a physical address to the nonvolatile storage device 105. In the erase operation, the controller 101 may provide an erase command and a physical address to the nonvolatile storage device 105.

The controller 101 may generate a command, an address, and data by itself independent of a request from the host system 200, and transmit the command, the address, and the data to the nonvolatile storage device 105. For example, the controller 101 may provide the nonvolatile storage device 105 with a command, an address, and data for performing a program operation, a read operation, and an erase operation involved in performing wear leveling, read reclaim, garbage collection, and the like. Such provision is independent of the request of the host system 200.

The host system 200 may communicate with the nonvolatile storage system 100 through at least one or a combination of various communication standards or interfaces such as universal serial bus (USB), serial AT attachment (SATA), serial attached SCSI (SAS), high speed interchip (HSIC), small computer system interface (SCSI), peripheral component interconnection (PCI), PCI express (PCIe), nonvolatile memory express (NVMe), universal flash storage (UFS), secure digital (SD), multiMedia card (MMC), embedded MMC (eMMC), dual in-line memory module (DIMM), registered DIMM (RDIMM), and load reduced DIMM (LRDIMM).

The host system 200 may provide the nonvolatile storage system 100 with a request for the secured area 110, and such a command may be, for example, an access request for the secured area 110.

The controller 101 may process the access request for the secured area 110.

For example, when the secured area 110 is the RPMB, the controller 101 may control the nonvolatile storage device 105 to perform an authenticated data write operation for storing data in the RPMB and an authenticated data read operation for reading the data from the RPMB.

The working memory 103 may operate under the control of the controller 101. The working memory 103 may buffer host chunks provided from the host system 200 and flush the buffered host chunks into the secured area 110 of the nonvolatile storage device 105. In an embodiment of the present disclosure, the host chunk may be secured data to be stored in the secured area 110 as a data piece of a predetermined size.

The nonvolatile storage device 105 may perform a write operation or a read operation in units of data groups each having a predetermined size, for example, a page size. That is, a single data group may be stored in the nonvolatile storage device 105 or read from the nonvolatile storage device 105 through a single write operation or read operation. In the present disclosure, a data group that is a target of a write operation is a write data group and a data group that is a target of a read operation is a read data group. For example, a single data group may comprise an N number of chunks. That is, the N number of chunks may be stored in or read from the nonvolatile storage device 105 through a single write operation or read operation.

As described above, the nonvolatile storage system 100 may store normal data in the nonvolatile storage device 105 or read the normal data from the nonvolatile storage device 105 in units of page sizes each of 4K bytes, for example, while storing or reading security data into or from the secured area 110 in units of chunks each having a size of 256 bytes, for example. That is, the nonvolatile storage system 100 may perform, on the security data, a write operation or a read operation in smaller units than the normal data.

However, in order to efficiently manage the storage space and map data of the nonvolatile storage device 105, the nonvolatile storage system 100 may align the security data, which is buffered in the working memory 103, in a data group size to be described below and may store, in the secured area 110, the security data, which is aligned in the data group size. That is, like the normal data, the nonvolatile storage system 100 may also perform a write operation or a read operation on the security data in units of data groups.

A write operation using a read-back merge scheme is an operation of performing a read-back operation on security data, which is a data group size and already stored in the secured area 110, when the security data, which is buffered in the working memory 103, is not aligned in the data group size; performing a merge operation on at least a portion of the read-back security data and the buffered security data to generate write data aligned in the data group size; and storing the generated write data in the secured area 110. That is, the write operation using the read-back merge scheme may include the read-back operation, the merge operation, and the storage operation.

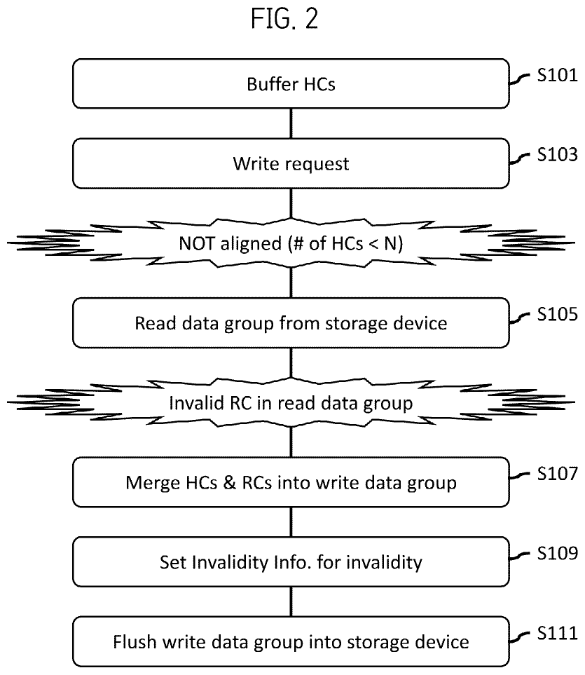

FIG. 2 schematically illustrates a write operation using the read-back merge scheme in accordance with an embodiment of the present disclosure.

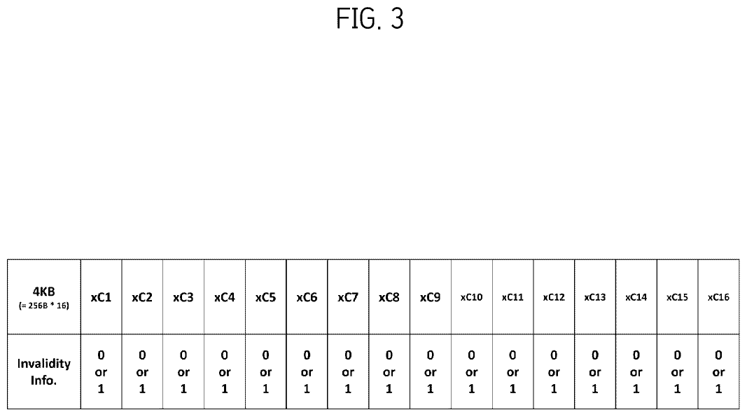

FIG. 3 to FIG. 7 schematically illustrate data groups, host chunks, read chunks, and invalid information in accordance with an embodiment of the present disclosure.

Referring to FIG. 2, a write operation using the read-back merge scheme in accordance with an embodiment of the present disclosure may start when the nonvolatile storage system 100 sequentially receives host chunks HCs provided from the host system 200.

In S101, the controller 101 may buffer, in the working memory 103, the host chunks HCs sequentially provided from the host system 200.

Referring to FIG. 3, a data group in accordance with an embodiment of the present disclosure may comprise an N number of chunks xCs. FIG. 3 illustrates a data group in accordance with an embodiment of the present disclosure comprises a 16 number of chunks xC1 to xC16. FIG. 3 illustrates an embodiment in which a chunk xC has a size of 256 bytes and the data group has a size of 4K bytes (=256 bytes*16).

Referring to FIG. 3, the nonvolatile storage system 100 may store the 16 number of chunks xC1 to xC16 as a write data group in the secured area 110 of the nonvolatile storage device 105 through a single write operation or may read the 16 number of chunks xC1 to xC16 as a read data group from the secured area 110 through a single read operation.

Each of the N number of chunks xCs may be a host chunk HC or a read chunk RC. The host chunk HC may be provided from the host system 200 and may be stored in the secured area 110, and the read chunk RC may be read from the secured area 110.

Referring to FIG. 2, in S101, the controller 101 may sequentially receive, from the host system 200, the host chunks HCs, which are for forming a write data group, and may buffer the received host chunks HCs in the working memory 103.

As described above, a single data group may comprise the N number of chunks xCs. Each of the N number of chunks xCs may be a host chunk HC or a read chunk RC. In the present disclosure, when the number of host chunks HCs provided from the host system 200 and buffered in the working memory 103 reaches the N number and the host chunks HCs completely form a single write data group, the host chunks HCs are expressed as being “aligned” to the write data group, and when the number of host chunks HCs provided from the host system 200 and buffered in the working memory 103 does not yet reach the N number and the host chunks HCs do not completely form a single write data group, the host chunks HCs are expressed as being “not aligned” to the write data group. In the embodiment illustrated in FIG. 3, when the number of host chunks HCs provided from the host system 200 and buffered in the working memory 103 reaches the 16 number and the host chunks HCs completely form a single write data group, the host chunks HCs are aligned to the write data group, and when the number of host chunks HCs provided from the host system 200 and buffered in the working memory 103 is less than the 16 number and the host chunks HCs do not completely form a single write data group, the host chunks HCs are not aligned to the write data group.

Referring to FIG. 2, in S103, the controller 101 may receive a write request from the host system 200. The write request may be a request for storing, in the secured area 110, the host chunks HCs buffered in the working memory 103 through S101.

The host chunks HCs currently buffered in the working memory 103 may not yet be aligned to the write data group (indicated as “NOT aligned (# of HCs<N)” in FIG. 2). That is, the number of host chunks HCs currently buffered in the working memory 103 may not yet reach the N number and the host chunks HCs do not completely form a single write data group.

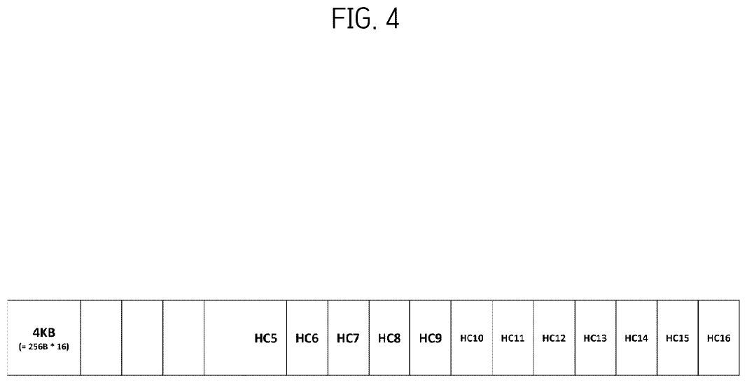

As illustrated in FIG. 4, in the write operation according to the write request, the number of host chunks HC5 to HC16 currently buffered in the working memory 103 is 12 number and the host chunks HCs do not completely form a single write data group.

In this case, in S105, the controller 101 may control the nonvolatile storage device 105 to read the read data group from the secured area 110. The read data group may be a data group stored in the secured area 110. The read data group may be previously a write data group, which has been stored in the secured area 110 because the host chunks HCs provided from the host system 200 and buffered in the working memory 103 have been aligned to the write data group in a previous write operation using the read-back merge scheme.

Referring to FIG. 3, when a data group is stored in the nonvolatile storage device 105, invalidity information (indicated as “Invalidity Info.” in FIG. 3) indicating whether the data group is invalid may be stored in the nonvolatile storage device 105. For example, the invalidity information may be stored in the meta-area 130. The invalidity information may indicate whether the data group includes an invalid chunk. The invalid chunk may be a chunk including an error. In the present disclosure, an error may include not only an error internally included in data but also an error due to the physical distribution of a threshold voltage of a memory cell storing the data. In accordance with an embodiment of the present disclosure, the invalidity information may be data indicating whether a corresponding chunk is invalid. Accordingly, when the data group includes at least one invalid chunk, the invalidity information indicates that the invalid chunk is invalid. In accordance with an embodiment of the present disclosure, among a plurality of chunks xCs included in the data group, a chunk xC having corresponding invalid information indicating invalid is evaluated to be invalid, and a chunk xC having corresponding invalid information indicating valid is evaluated to be valid. FIG. 3 illustrates invalid information to which 1 bit is allocated to a chunk having a size of 256 bytes. Accordingly, FIG. 3 illustrates invalid information, to which 16 bits are allocated for a data group comprising a 16 number of chunks and having a size of 4K bytes.

Referring to FIG. 2, the read data group read in S105 may include an invalid read chunk RC (indicated as “Invalid RC in read data group” in FIG. 2). Whether the read data group includes the invalid read chunk RC may be identified from the invalid information, which corresponds to the read data group and is stored in the meta-area 130.

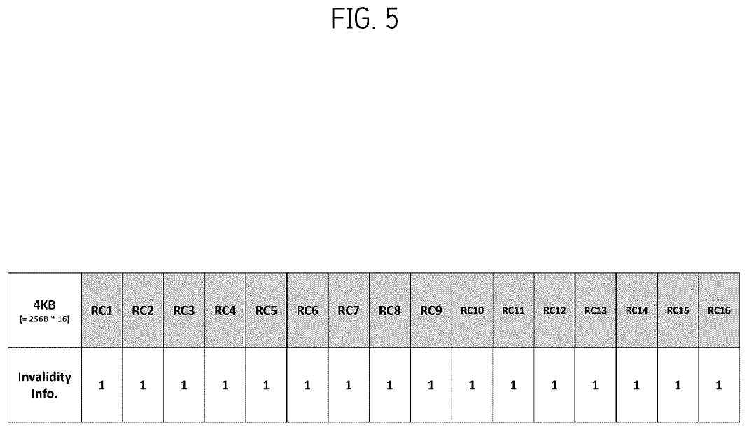

Referring to FIG. 5, the invalid information corresponding to each of a plurality of read chunks RC1 to RC16 included in the read data group read in S105 may indicate that a corresponding read chunk RCx is invalid. That is, only the invalid read chunk RC may be individually evaluated to be invalid among the plurality of read chunks RC1 to RC16 included in the read data group read in S105. Although FIG. 5 illustrates the invalid information corresponding to each of the plurality of read chunks RC1 to RC16 included in the read data group read in S105 indicates that the corresponding read chunk RCx is invalid, in accordance with an embodiment of the present disclosure, each of the plurality of read chunks RC1 to RC16 may be individually evaluated to be invalid or valid and the evaluation may be made based on the invalid information stored in the meta-area 130.

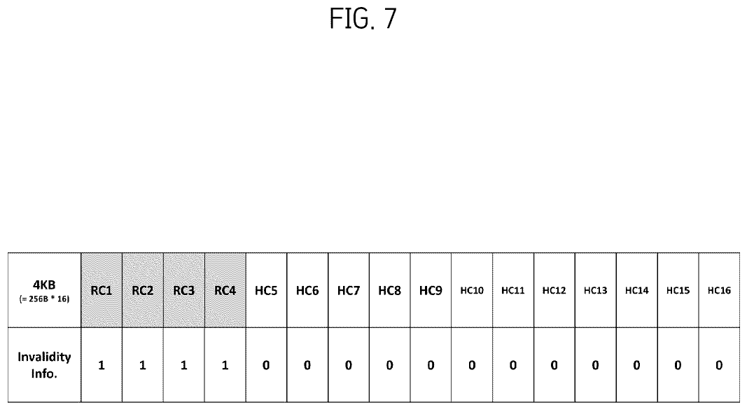

When the validity or invalidity of read data is evaluated on a data group basis, all 16 number of read chunks RC1 to RC16 included in the read data group may be evaluated to be invalid if the read data group is evaluated to be invalid. On the other hand, referring to FIGS. 2 and 7 in accordance with an embodiment of the present disclosure, each of the 16 number of read chunks RC1 to RC16 included in the read data group may be individually evaluated to be invalid or valid.

Referring to FIG. 2, in S107, the controller 101 may merge the host chunks HCs, which are currently buffered in the working memory 103 but are not yet aligned to a write data group, and some of the read chunks RCs included in the read data group read in S105. The merged chunks may be aligned to the write data group. That is, the number of the merged chunks reaches the N number, and accordingly the merged chunks may completely form a single write data group.

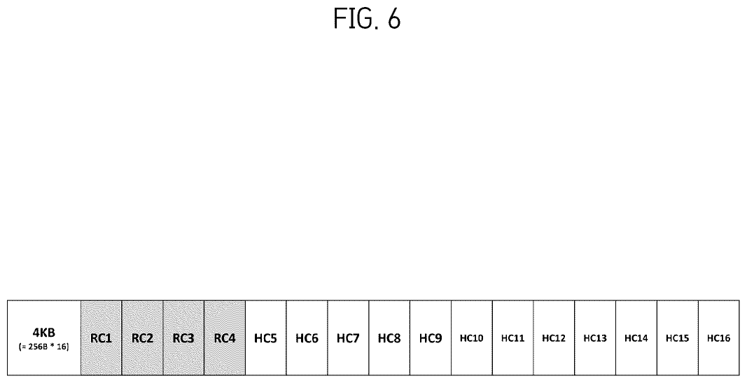

Referring to FIG. 6, for example, the controller 101 in S107 may merge the 12 number of host chunks HC5 to HC16, which are currently buffered in the working memory 103, and the 4 number of read chunks RC1 to RC4 included in the read data group read in S105. The number of the merged chunks RC1 to RC4 and HC5 to HC16 reaches the 16 number and may be aligned to a write data group.

Referring to FIG. 2, the controller 101 may generate invalid information for each of the plurality of chunks RC1 to RC4 and HC5 to HC16 included in the write data group generated through the merging in S107. The invalid information may be information indicating whether each of the plurality of chunks RC1 to RC4 and HC5 to HC16 is an invalid chunk. The invalid information may be information generated for each of the plurality of chunks RC1 to RC4 and HC5 to HC16 included in the write data group. Accordingly, when the write data group includes at least one invalid chunk, the invalid information indicates that the invalid chunk is invalid.

Referring to FIGS. 5 to 7, the invalid information corresponding to each of the read chunks RC1 to RC16 included in the read data group read in S105 indicates that a corresponding read chunk RCx is invalid, and accordingly, each of the 16 number of read chunks RC1 to RC16 included in the read data group is individually evaluated to be invalid. Therefore, in S107, each of the 4 number of read chunks RC1 to RC4 merged with the 12 number of host chunks HC5 to HC16 buffered in the working memory 103 to form the write data group is individually evaluated to be invalid. As a result, since the write data group generated through the merging in S107 includes the 4 number of read chunks RC1 to RC4 individually evaluated to be invalid, only each of the 4 number of read chunks RC1 to RC4 is individually evaluated to be invalid. Accordingly, invalidity information for each of the 4 number of read chunks RC1 to RC4 among the 16 number of chunks RC1 to RC4 and HC5 to HC16 included in the write data group indicates that only each of the 4 number of read chunks RC1 to RC4 is invalid.

Referring to FIG. 2, in S111, the controller 101 may flush the write data group, for which the invalidity information has been generated through S109, into the nonvolatile storage device 105. For example, the controller 101 may control the nonvolatile storage device 105 to store the write data group in the secured area 110. In such a case, the controller 101 may control the nonvolatile storage device 105 to store, in the meta-area 130, the invalidity information corresponding to the write data.

Referring to FIG. 7, when the write data group previously stored in the nonvolatile storage device 105 through S111 is subsequently read as a read data group from the nonvolatile storage device 105 through a read operation, the invalid information corresponding to each chunk included in the read data group will indicate the corresponding chunk as invalid when the corresponding chunk is invalid. Accordingly, depending on whether each chunk included in the read data group actually includes an error, the chunk is to be evaluated to be invalid. Accordingly, an individual chunk is to be evaluated as failed when the individual chunk actually has an error among the chunks included in the read data group read through the read operation.

As described above, in accordance with an embodiment of the present disclosure, the invalid information stored in the meta-area 130 may indicate whether each chunk included in the data group stored in the secured area 110 is invalid. Accordingly, depending on whether each chunk included in the data group actually includes an error, only a chunk including an error may be evaluated to be invalid. As a result, among the chunks included in the data group, only a chunk including an error may be evaluated to be invalid and a chunk including no error may be evaluated to be valid.

The write data group stored as described above may become a read data group as a target of a read-back operation in a write operation, which uses a read-back merge scheme and is to be performed on host chunks to be subsequently provided from the host system 200. In the write operation using the read-back merge scheme, a read data group read-back from the secured area 110 may comprise a plurality of read chunks, and whether each of the read chunks is invalid may be checked through the invalid information corresponding to the read data group and stored in the meta-area 130. The invalid information corresponding to each read chunk may indicate that the read chunk is invalid. That is, when the read data group includes an invalid read chunk, the entire read data group is not evaluated to be invalid, but only the invalid read chunk may be individually evaluated to be invalid. When the read chunk evaluated to be invalid is merged with the host chunk to form a write data group, the entire write data group is not evaluated to be invalid, but only the invalid chunk may be individually evaluated to be invalid. In the data group stored in the above secured area 110, the remaining chunks other than chunks evaluated to be invalid may be evaluated to be valid and used.

The embodiments of the present disclosure described above are not limited by the aforementioned embodiments and the accompanying drawings, and it will be apparent to those skilled in the art to which the present disclosure pertains that various replacements, modifications, and changes can be made without departing from the technical spirit of the present disclosure. Furthermore, the embodiments may be combined to form additional embodiments.

What is claimed is:

1. An operating method of a storage system, the operating method comprising:
buffering an L number of first data chunks in a memory, L being a natural number of 1 or more;
reading a read data group from a storage device; and
storing a write data group, which comprises the L number of first data chunks and an M number of second data chunks, in the storage device and storing invalidity information on each of the first and second data chunks in the storage device, M being a natural number of 1 or more,
wherein each of the read data group and the write data group comprises an N (=L+M) number of chunks, and
wherein the read data group comprises the second data chunks.

2. The operating method of claim 1,
further comprising reading, from the storage device, the invalidity information on each of chunks included in the read data group,
wherein the read invalidity information includes the invalidity information on each of the second data chunks.

3. The operating method of claim 1,
wherein the read data group is read from a replay protected memory block (RPMB) included in the storage device, and
wherein the write data group is stored in the RPMB.

4. The operating method of claim 1, wherein the read data group is read from a secured area included in the storage device.

5. The operating method of claim 4, wherein the secured area is accessible according to authentication.

6. The operating method of claim 1, wherein the write data group is stored in a secured area included in the storage device.

7. The operating method of claim 6, wherein the secured area is accessible according to authentication.

8. The operating method of claim 1, wherein the invalidity information is stored in a meta-area included in the storage device.

9. The operating method of claim 2, wherein the invalidity information is read from a meta-area included in the storage device.

10. A storage system comprising:
a memory;
a secured storage area and a meta storage area; and
a controller configured to:
buffer an L number of first data chunks in the memory, L being a natural number of 1 or more,
read a read data group from the secured storage area, and
store a write data group, which comprises the L number of first data chunks and an M number of second data chunks, in the secured storage area and store invalidity information on each of the first and second data chunks in the meta storage area, M being a natural number of 1 or more,
wherein each of the read data group and the write data group comprises an N (=L+M) number of chunks, and
wherein the read data group comprises the second data chunks.

11. The storage system of claim 10,
wherein the controller is further configured to read, from the meta storage area, the invalidity information on each of chunks included in the read data group, and
wherein the read invalidity information includes the invalidity information on each of the second data chunks.

12. The storage system of claim 10, wherein the secured storage area includes a replay protected memory block (RPMB).

13. The storage system of claim 10, wherein the secured storage area is accessible according to authentication.
